(19) United States
(12) Patent Application Publication
(10) Pub. No.: US 2004/0126632 A1
(43) Pub. Date: Jul. 1, 2004

(54) Regenerative fuel cell electric power plant and operating method

(76) Inventors: Martin T. Pearson, Burnaby (CA); Eric W. Fuller, Coquitlam (CA); Patricia S. Chong, Burnaby (CA); Patrick Koropatnick, West Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/331,138

(22) Filed: Dec. 27, 2002

(51) Int. Cl. H01M 8/18; H01M 8/04

(52) U.S. Cl. 429/17; 429/21; 429/23

(57) ABSTRACT

Regenerative fuel cell electric power plants and operating methods therefor are provided. An embodiment of the present power plant comprises a regenerative fuel cell stack, supply systems for supplying an oxidant gas to the oxidant inlet and a fuel gas to the fuel inlet, respectively, of the stack when operating in power generation mode, a power supply system for connecting a power source to the stack for operation in electrolysis mode, a system for supplying a humidified carrier gas to the stack when operating in electrolysis mode; and, a storage system for storing hydrogen generated during electrolysis. An embodiment of the present comprises: in power generation mode, supplying an oxidant gas comprising oxygen and a fuel gas comprising hydrogen to the stack to generate electric power, and supplying the electric power to a first electrical load; and, in electrolysis mode, supplying a humidified carrier gas to the stack, applying an electric current to the stack, electrolyzing at least a portion of the water in the carrier gas to generate hydrogen and an exhaust gas, and storing at least a portion of the generated hydrogen.

### BACKGROUND OF THE INVENTION

1. Field of the Invention

The present invention relates to fuel cell electric power plants and methods of operating them. In particular, the present invention relates to regenerative fuel cell electric power plants and associated operating methods.

2. Description of the Related Art

Fuel cells are known in the art. Fuel cells electrochemically react a fuel stream comprising hydrogen and an oxidant stream comprising oxygen to generate an electric current. Fuel cell electric power plants have been employed in transportation, portable and stationary applications.

Stationary and portable applications include distributed power generation, back-up power, peak power, and uninterruptible power supply (UPS) systems. Distributed power generation relates to providing electrical power to residential, commercial and/or industrial customers instead of, or as a supplement to, the utility power grid. Power plants in such applications typically operate continuously. They are particularly suited to situations where the power grid is not available or sufficiently reliable. Peak power systems are intended to supplement the power grid, providing electrical power intermittently during periods of peak use when sufficient grid power may not be available or when the rate charged by the utility increases. Back-up power and UPS systems provide electrical power during periods when the grid, or other primary power source, is unavailable.

In addition, UPS systems must be able provide power to the consumer substantially continuously, i.e., they must be “instant on” so that the loss of grid power does not result in an interruption of power supply to the consumer. Consumers who rely on electronic equipment, for example, cannot tolerate even minor interruptions in power supply. In this regard, the Information Technology Industry Council has issued guidelines for voltage dropouts, which are not to exceed 20 milliseconds. In this context, a voltage dropout includes both severe RMS voltage sags and complete interruptions of the applied voltage.

Conventional back-up power and UPS systems employ rechargeable battery banks for supplying electric power when the power grid is interrupted. For applications where a relatively short run time is acceptable, battery banks may be the sole source of back-up power. Where longer run times are required, however, such systems also employ a generator to supply power. In this case, the battery banks provide immediate power until the generator can come online. Such systems also include a rectifier for recharging the battery banks, power distribution systems and control and monitoring systems. Inverters and/or DC/DC converters may also be employed to provide power to AC loads or DC loads, respectively. The battery banks are typically re-charged when the power grid is restored.

Valve regulated lead acid (VRLA) batteries are most often employed in the battery banks. The number of batteries depends on the required run time for lower power applications (2-7.5 kW), or systems including a generator, run times of 15 minutes or less are common; other systems employing batteries alone may require run times of 4-8 hours, or more. Current limits are set on recharging of batteries to avoid damaging them. In practice, VRLA batteries are recharged at a 6×-10× rate, that is, the time to fully re-charge the batteries is six to ten times longer than their run time.

Conventional back-up power and UPS systems have several significant disadvantages. For example, particularly in applications requiring extended battery run time (e.g., >4 hr), VRLA battery banks are large and heavy. A large battery bank requires a significant amount of indoor floor space for installation, which can be expensive. In addition, the weight of the battery bank may require indoor floor space with increased loading capacity, further increasing cost. Environmental regulations relating to the storage and operation of VRLA batteries also add to increase installation costs. Operating and maintaining a generator further adds to the cost and complexity of systems employing them.

Back-up power and UPS systems employing fuel cell electric power plants have also been described. The described systems have several disadvantages relating to the supply of reactants to the fuel cells, the time it takes for the fuel cells to produce full power, and their surge demand capacity, for example.

Reactants must be supplied to the fuel cells in order to generate electricity. Hydrogen may be supplied from a storage unit, such as pressurized gas or metal hydride tanks. Alternatively, the fuel cell power plant may include a fuel processing system for reforming a hydrocarbon fuel to generate hydrogen. In the former case, hydrogen storage must be sufficient to enable the desired run time of the fuel cells; for extended run times the bulk and/or cost of hydrogen storage, particularly metal hydrides, can be undesirably high. At present, the cost of replenishing stored hydrogen is also higher than desired. Reforming fuel to provide hydrogen can reduce or eliminate the need to store hydrogen, but the associated fuel processing system increases the cost and complexity of the power plant.

Fuel cell output is proportional to the amount of reactants supplied. On start-up, there is typically a delay until the fuel cells reach full operating power. For this reason, back-up or UPS systems solely employing fuel cells are inadequate for some applications because they are not “instant on”. One approach has been to keep the fuel cells in such systems continuously running: either supplying power to the load or in a low output “stand-by” mode. While this approach improves response time, it further exacerbates hydrogen storage issues by significantly increasing hydrogen consumption. In addition, operational lifetime of the power plant may be adversely affected compared to systems where the power plant is operated intermittently.

Fuel cells can be damaged if the load requirements exceed their maximum output. Thus, in power plants solely employing fuel cells, the rated output of the fuel cell stack is generally matched to the expected peak load. In applications where transient load increases are significantly higher than normal load requirements, this necessitates a larger size and output fuel cell stack than required for normal operation in order to deal with surge demand. This, in turn, undesirably increases the cost of the power plant.

Another approach employs hybrid power plants including fuel cells and secondary batteries. The secondary batteries can provide power while the fuel cells come on line, so that the power plant can be “instant on.” The batteries can also provide surge demand capability. These systems, however, do not adequately address the hydrogen supply issues discussed above.

Fuel cell power plants employing electrolysis cells have also been described. Hydrogen (and oxygen) formed by electrolyzing water can be used to replenish or supplement stored hydrogen, alleviating hydrogen storage problems. However, in power plants employing separate fuel cell and electrolysis cell stacks, the additional cost and complexity of the system related to the electrolysis function offset this advantage.

Power plants employing regenerative fuel cell stacks, i.e., stacks that can be operated as fuel cells to generate electricity and as electrolysis cells to generate reactants, have also been described. These power plants can also have disadvantages. For example, the liquid water supplied to the anodes and/or cathodes of the stack needs to be removed from the stack before it can generate electricity, and this can exacerbate the delay in reaching full operating power mentioned earlier. As another example, introducing water into the stack may cause some fuel cell components, such as catalyst particles, to be washed out of the stack, which can adversely impact performance and/or lifetime of the stack.

It is desirable to have a fuel cell electric power plant that requires less space than conventional systems employing VRLA batteries and that more efficiently utilizes stored hydrogen. Further, it is desirable to increase the reliability of the power supply, without significantly increasing the cost. Thus, a less costly, less complex and/or more efficient approach to fuel cell-based power plants is desirable. The present invention addresses the disadvantages of conventional power supply systems and provides further related advantages.

### BRIEF SUMMARY OF THE INVENTION

A regenerative fuel cell electric power plant and operating method therefor are described. In one embodiment, the present method comprises: in a power generation mode, supplying an oxidant gas comprising oxygen and a fuel gas comprising hydrogen to the stack to generate electric power, and supplying the electric power to one or more electrical loads; and in an electrolysis mode, supplying a humidified carrier gas to the stack, applying an electric current to the stack, electrolyzing at least a portion of the water in the carrier gas to generate hydrogen and an exhaust gas, and storing at least a portion of the generated hydrogen.

In other embodiments, electrolysis mode generates a gas stream comprising hydrogen and water, and the method further comprises removing at least a portion of the water from the gas stream.

In further embodiments the current is applied to the stack by a constant current source. If desired, the constant current source may be clamped at a limit voltage.

In yet other embodiments, the present method further comprises measuring the stack voltage in electrolysis mode, interrupting applying the electric current to the stack when the stack voltage reaches or exceeds a predetermined upper voltage limit, and re-applying the electric current to the stack when the stack voltage drops to or below a predetermined lower voltage limit.

In still other embodiments the power plant includes a storage battery connectable to the electrical load, and during power generation mode the method further comprises: connecting the battery to the load in a first time period; connecting the stack to the load in a second time period when the stack reaches a predetermined power output; and disconnecting the battery from the load.

### BRIEF DESCRIPTION OF THE DRAWINGS

FIGS. 1-4 are schematic illustrations of some embodiments of the present fuel cell electric power plant.

FIG. 5 is a plot of stack potential versus stack current for PEM fuel cell stack operated in power generation mode and electrolysis mode.

FIG. 6 is a plot of carbon dioxide (CO₂) concentration in the electrolysis exhaust stream as a function of stack voltage for a PEM fuel cell module operated in electrolysis mode.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE INVENTION

In the following description, certain specific details are set forth in order to provide a thorough understanding of the various embodiments of the invention. However, one skilled in the art will understand that the invention may be practiced without these details. In other instances, well-known structures associated with fuel cells, fuel cell stacks, batteries and fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

In one embodiment, the present power plant comprises: a regenerative fuel cell stack; supply systems for supplying an oxidant gas to the oxidant inlet and a fuel gas to the fuel inlet, respectively, of the stack when operating in power generation mode; a power supply system for connecting a power source to the stack for operation in electrolysis mode; a system for supplying a humidified carrier gas to the stack when operating in electrolysis mode; and, a storage system for storing hydrogen produced during electrolysis.

In power generation mode, hydrogen is consumed at the negative electrodes (anodes) of fuel cells and oxidant is consumed at the positive electrodes (cathodes) to produce electrical power. The electrical power can be supplied to one or more loads. In electrolysis mode, the stack consumes electrical power and water to generate hydrogen and oxygen. At least a portion of the water present in the humidified carrier gas is electrolyzed in the stack, generating hydrogen at the negative electrodes (cathodes) of the fuel cells and oxygen at the positive electrodes (anodes). At least a portion of the hydrogen is stored for later use in power generation mode.

The particular type of fuel cells making up the stack is not essential to the present power plant, and persons skilled in the art can readily select suitable fuel cells for a given application. For example, in some embodiments of the present power plant, polymer electrolyte membrane (PEM) fuel cell stacks are employed.

The oxidant gas can be pure oxygen or an oxygen-containing gas, such as air. In the former case, the oxidant supply system may include a stored oxygen supply; in the latter case, air may be supplied to the stack at ambient or higher pressure. The oxidant gas may be humidified, if desired, as is often the case in PEM fuel cell-related applications, for example.

The humidified gas supply system supplies water to the stack that is electrolyzed during electrolysis mode. The water is present as vapor and/or droplets entrained in a carrier gas. The carrier gas may comprise air or an inert gas, such as nitrogen, for example. In some embodiments, the oxidant and humidified gas or carrier gas are the same and the associated supply systems may share common components. Indeed, in further embodiments, an integrated system supplies the oxidant and humidified gas to the stack.

The fuel supply system includes hydrogen storage equipment for storing the hydrogen fuel supplied to the stack during power generation mode. The hydrogen fuel may be substantially pure hydrogen. If desired, the fuel supply and hydrogen storage systems may share common hydrogen storage equipment. In some embodiments, these systems form an integrated system for supplying and storing hydrogen to the stack.

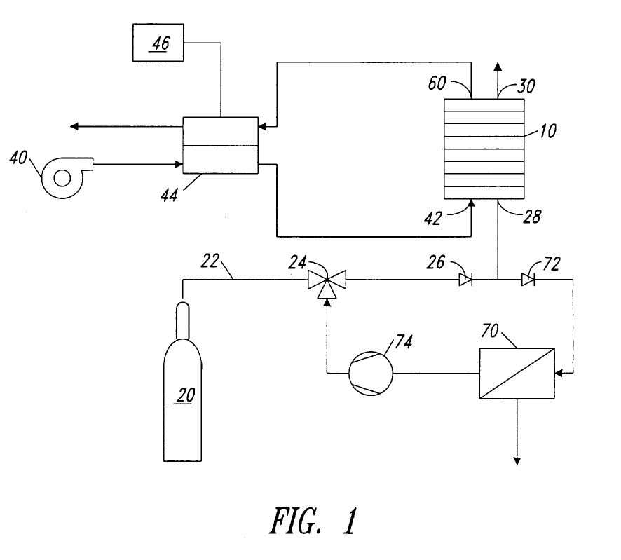

Several embodiments of the present power plant are schematically illustrated in FIGS. 1-4. In power generation mode, regenerative fuel cell stack 10 consumes hydrogen and oxygen and produces electric power. Hydrogen is supplied from hydrogen storage 20 via line 22, passing through valve 24 and check valve 26 to the fuel inlet 28 of stack 10. Anode exhaust exits stack 10 via fuel outlet 30. Oxidant (air in the illustrated embodiments) is supplied by air compressor 40 to stack 10 via oxidant inlet 42. Cathode exhaust exits the stack via oxidant outlet 60.

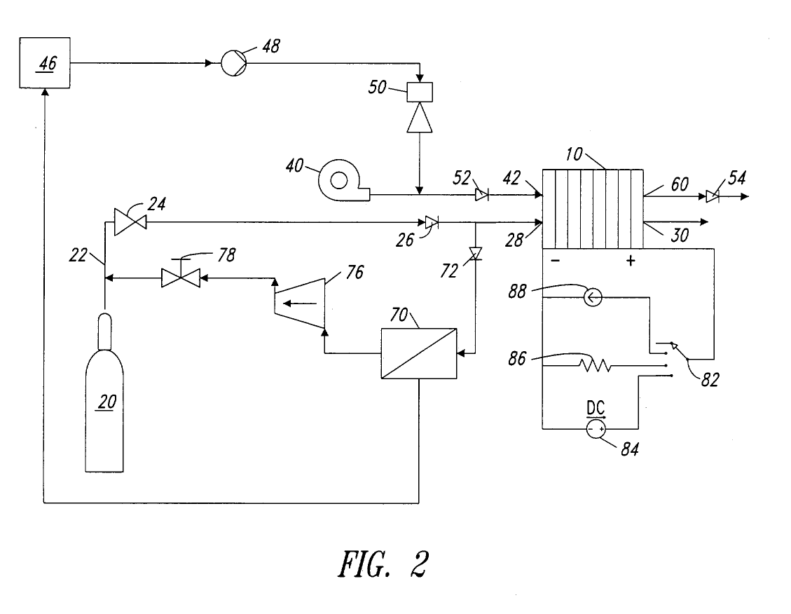

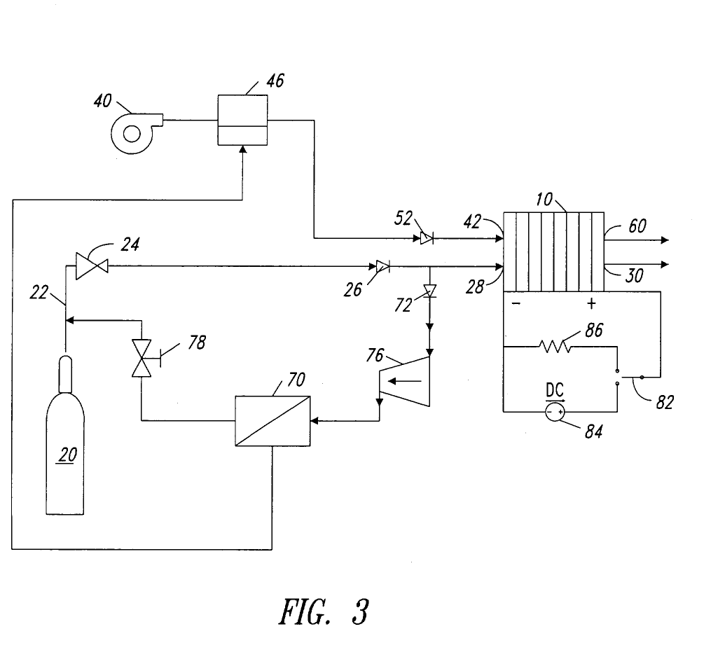

The incoming oxidant stream may be humidified before being directed to stack 10. For example, in the embodiment of FIG. 1, the incoming air stream is humidified in membrane exchange humidifier 44, which also receives the cathode exhaust from oxidant outlet 60. Water in the cathode exhaust is transferred across a water-selective membrane to the incoming oxidant stream. Alternatively, in the embodiment of FIG. 2, water from water supply 46 is pressurized by pump 48 and supplied to injector 50, which injects a fine stream of water to humidify the oxidant stream. As a further example, in FIG. 3 the oxidant stream is humidified by contacting it with hot water—water supply 46 is a heated water supply, such as a conventional hot water heater. The selection of humidifying means for the oxidant stream is not essential to the present power plant, and other suitable such means, including enthalpy wheels or pressure swing adsorption (PSA) units, will be apparent to persons skilled in the art.

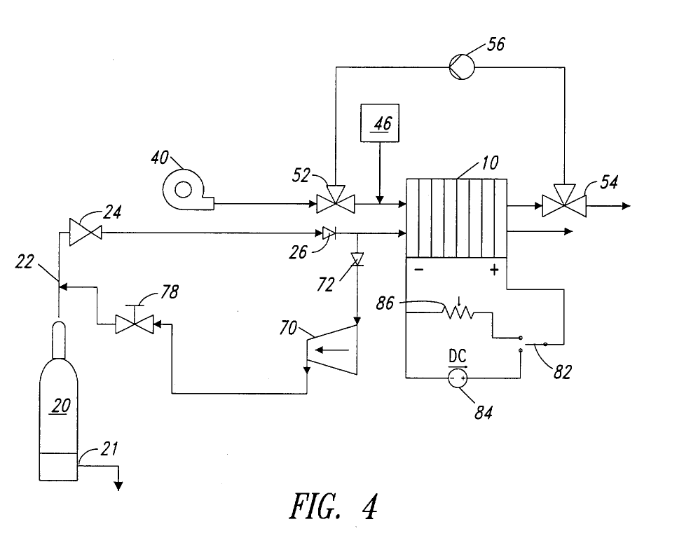

Humidification of the oxidant stream is not required, however. For example, in the embodiment of FIG. 4, water supply 46 may not supply water to the oxidant stream during power generation mode. Ambient air from compressor 40 may then be supplied to stack 10 without humidification.

For sake of clarity, comparable means for humidifying the fuel gas have not been shown. It is understood, however, that the present power plant may incorporate fuel humidification systems, if desired.

When stack 10 is operating in electrolysis mode, a humidified carrier gas (air in the illustrated embodiments) is supplied to oxidant inlet 42 via compressor 40. At least a portion of the water present in the humidified carrier gas is electrolyzed in stack 10, generating hydrogen and oxygen. An oxygen-enriched electrolysis exhaust gas exits via oxidant outlet 30, and may be vented to the atmosphere or stored for later use in power generation mode, if desired. The electrolysis exhaust gas typically comprises the carrier gas, oxygen, and water vapor and may also contain carbon dioxide.

The carrier gas and oxidant gas may have different relative humidities, depending on such factors as the stack operating conditions in power generation mode and the desired time required to fill the hydrogen storage in electrolysis mode. For example, in the embodiment of FIG. 1, water supply 46 may supply water to the cathode exhaust side of humidifier 44 during electrolysis mode, since extended operation will tend to deplete the water in the electrolysis exhaust. As another example, water supply 46 in the embodiment of FIG. 4 need not supply water to the air stream entering stack 10 during power generation mode, but may do so in electrolysis mode.

During electrolysis, hydrogen is directed out of stack 10 via anode outlet 30. This may be accomplished by closing a valve located at anode outlet 30 or in the anode exhaust line, for example, or otherwise preventing flow of hydrogen out anode outlet 30. The hydrogen stream is then stored in hydrogen supply 20.

The type of hydrogen storage is not essential to the present power plant. For example, hydrogen may be stored as a pressurized gas or a liquid, if desired. Alternatively, solid hydrogen storage media may be employed, including metal hydride (e.g., nickel metal hydride), chemical hydride (e.g., borohydrides) or carbon nanomaterials. Low pressure hydrogen gas storage suffers from relatively low volumetric and gravimetric energy densities, but is relatively inexpensive and simple to implement. As the pressure of the stored hydrogen increases, volumetric and gravimetric energy density increases. Metal hydrides exhibit superior volumetric energy densities, but their weight results in significantly inferior gravimetric energy densities compared to other hydrogen storage approaches. Associated temperature regulating equipment—metal hydrides are typically cooled to facilitate hydrogen adsorption and heated to facilitate hydrogen release—and (optionally) gas pressurizing equipment can also add cost and complexity to the overall power plant. Liquid hydrogen storage exhibits good volumetric and gravimetric energy densities, but the associated temperature regulating equipment required to maintain cryogenic storage also adds cost and complexity to the power plant. In addition, liquid hydrogen storage equipment experiences evaporative losses (“boil-off”) over time. Thus, the choice of hydrogen storage equipment for a given application balances various factors, including the size and weight of the equipment, cost and complexity of operation. Persons skilled in the art will be aware of such considerations and can readily select suitable hydrogen storage equipment for a given application.

The electrolysis hydrogen stream exiting the stack may also contain water that, if not removed, can accumulate undesirably in the hydrogen storage system. This is the case in PEM cells, for example, where hydrogen ion transport is accompanied by water transport across the membrane. Some types of hydrogen storage, such as hydrides, for example, are only suitable for storing dry, high-purity hydrogen. Thus, in some embodiments of the present power plant, the hydrogen storage system may comprise means for removing water from the hydrogen stream before introducing it into the hydrogen storage. For example, the embodiments illustrated in FIGS. 2-4 include dryer 70 for separating at least a major portion of the water from the electrolysis hydrogen stream. Dryer 70 may comprise hydrogen purification or gas drying equipment useful for this purpose, including hydrogen-permeable membrane separators (e.g., Pd or Pd alloy membranes), drying tubes (e.g., Nafion™ tubes), PSA units, desiccants or adsorbers, and condensers, for example. In other embodiments where the hydrogen storage is relatively insensitive to the presence of water, a knockout drum may also be employed. The hydrogen storage equipment could also be adapted to allow water that collects therein to be drained, if desired. For example, storage 20 in FIG. 4 includes drain 21 for removing accumulated water. The selection of particular apparatus for removing water from the electrolysis hydrogen stream, if employed, is not essential to the present power plant and persons skilled in the art can readily choose suitable such apparatus for a given application.

The hydrogen storage system also comprises means for moving hydrogen from the stack to the hydrogen storage. Such means may be active or passive, and may include means for compressing the electrolysis hydrogen gas.

In some embodiments, the pressure of hydrogen in the hydrogen storage equipment exceeds the pressure of the electrolysis hydrogen exiting the stack. For example, in FIGS. 2-4, stack 10 may operate at ambient pressure while hydrogen storage 20 comprises compressed hydrogen tanks, which can store hydrogen at pressures of up to 700 bar (10,000 psi) or more. The hydrogen storage system may therefore comprise means for compressing the electrolysis hydrogen gas stream, such as compressor 76, to at least a storage pressure. Other suitable compressing means may be employed, including blowers, pumps, boosters, or ejectors, for example. Single- and multi-stage compression may be employed, as desired. Thus, it is understood that compressor 76 may comprise any suitable gas compressing means.

Correspondingly, the hydrogen storage system may also comprise means for reducing the pressure of the hydrogen fuel from a storage pressure to a stack operating pressure. In FIGS. 2-4, for example, reducing valve 24 reduces the pressure of the fuel from storage 20 to a lower operating pressure of stack 10. Valve 78 can be closed in power generation mode to prevent gas flow in the reverse direction. The selection of pressure reducing means is not essential to the present power plant, and other pressure reducing means, including expanders, differential pressure regulators or expanded lines, may also be employed.

As shown in FIGS. 2 and 3, compressor 76 may precede or follow dryer 70. Generally, it is more energetically efficient to dry the hydrogen gas after compression. However, most compressing equipment is adversely affected by water in the gas stream and equipment designed to compress “wet” gases can be significantly more expensive. Thus, for a given application a balance between efficiency and cost will likely determine the order in which the hydrogen gas is dried and compressed.

The electrolysis hydrogen stream need not be compressed prior to storage, however, provided the power plant includes means for moving the hydrogen to the hydrogen storage equipment. FIG. 1, for example, illustrates an embodiment of the present power plant wherein the operating pressure of fuel in stack 10 is comparable to the pressure of hydrogen in storage 20. Hydrogen exiting stack 10 is directed, via 3-way valve 24, to storage 20 by pump 74. Pump 74 does not compress the hydrogen gas, however. In a further embodiment, storage 20 comprises a metal hydride storage tank and associated temperature regulating equipment. In electrolysis mode, storage tank 20 is cooled to facilitate hydrogen storage. This, in turn, creates a partial vacuum in line 22, which can be employed to move hydrogen from stack 10 to be stored. Thus, in this embodiment, pump 74 may be omitted.

Water from the dry hydrogen gas may be vented to the atmosphere or recovered to increase the water conservation efficiency of the power plant, if desired. For example, in FIGS. 2 and 3, water collected in dryer 70 is redirected to water supply 46 for use in humidifying the incoming oxidant gas. Although not shown, a water recovery apparatus may also be employed to recover water from the anode and/or cathode exhaust and store it for electrolysis purposes. It is understood, however, that the present power plant may incorporate such water recovery systems, if desired.

In power generation mode, electrical power is supplied to load 86, which may be one or more constant and/or variable loads. The present power plant may further comprise inverters and/or DC/DC converters for providing power to AC loads or DC loads, respectively. In electrolysis mode, power supply 84 is connected across stack 10. Power supply 84 is connected to stack 10 so that it reverses the flow of current through the stack while maintaining the same voltage polarity as during power generation mode. The power supply system may also include circuits and associated controls for pulsing the stack during electrolysis mode to maintain or recover performance of the present power plant, as will be discussed in further detail, below. The selection of power supply is not essential to the present power plant, however, and any suitable DC power source capable of providing DC current to the stack at a voltage greater than the stack open circuit voltage may be employed.

Note that the particular arrangement of humidified carrier gas feed and hydrogen supply shown in the illustrated embodiments are not essential to the present power plant. For example, the humidified carrier gas could be supplied to oxidant outlet 30. Indeed, the humidified carrier gas could be supplied to the fuel inlet or outlet of stack 10, and a hydrogen gas collected from the oxidant inlet or outlet, if desired; in this case, power supply would be connected to stack 10 so that the flow of current would be the same as in power generation mode, of course. Persons of ordinary skill in the art can readily determine corresponding piping and/or valving changes that can be made, depending on a selected arrangement of humidified carrier gas feed and hydrogen supply.

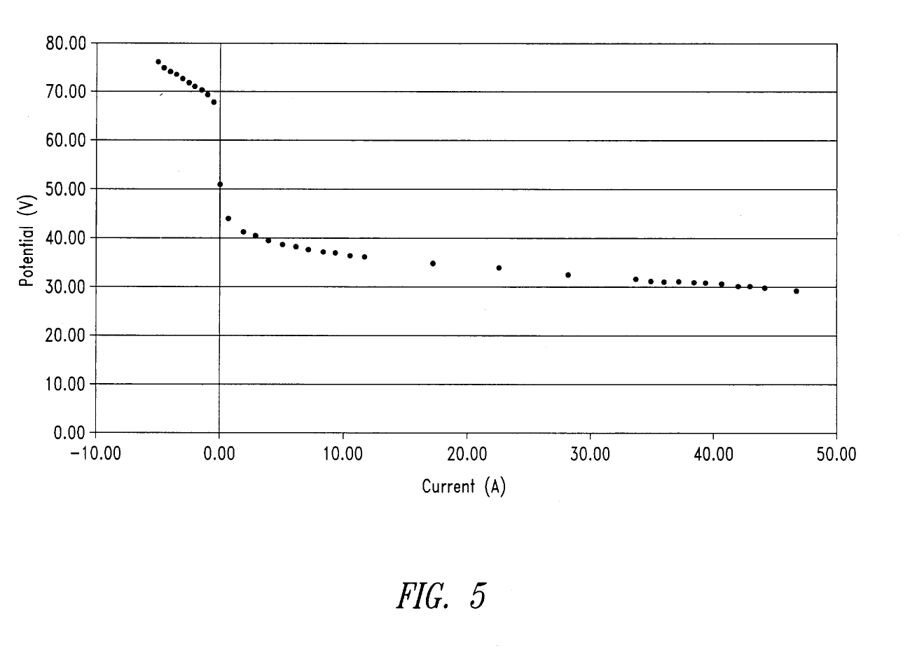

FIG. 5 is a plot of stack potential versus stack current for a 47-cell NEXA™ fuel cell stack operated in power generation mode and electrolysis mode. In power generation mode, hydrogen and humidified air (25° C., 100% RH) were supplied to the stack. In electrolysis mode, humidified air (25° C., 100% RH) was supplied to the cathode inlet of the stack at 60 SLPM, and a constant current source applied 0.5-5.0 A to the stack in 0.5 A increments. The portion of the voltage curve to the right of the y-axis corresponds to operation in power generation mode, while the portion of the curve to the left of the y-axis corresponds to electrolysis mode operation.

The applicant has found that the voltage required to sustain a given rate of hydrogen production increases over time in electrolysis mode. Without being bound by theory, the applicant believes that this effect is due to oxidation of the catalyst at the positive electrodes of the fuel cells, which reduces its activity. The applicant has also found that damage to the carbon components of the fuel cells can occur if the voltage of the stack rises above a threshold voltage limit. This is evidenced by increasing concentration of carbon dioxide in the electrolysis hydrogen gas stream, which correlates with loss of performance and/or lifetime issues for the stack.

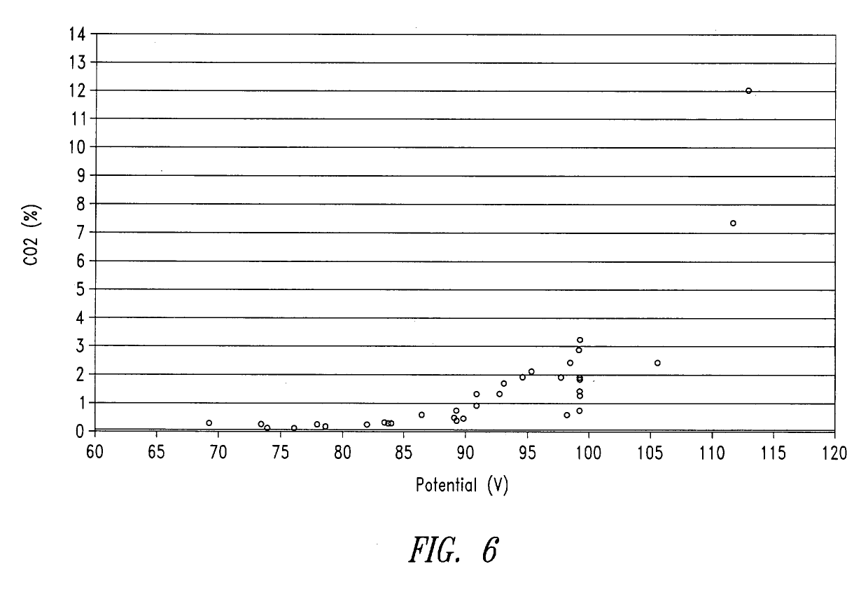

FIG. 6 is a plot of carbon dioxide (CO₂) concentration in the electrolysis exhaust stream as a function of stack voltage for a 47-cell NEXA™ fuel cell module operated in electrolysis mode. The stack was supplied with 60 SLPM of humidified air (25° C., 100% RH) and a constant current source supplied up to 4.0 A to the stack. A sample of the electrolysis exhaust stream was taken at various stack voltages and the CO₂ concentration determined by gas chromatography. At stack voltages greater than 90 V, the CO₂ concentration begins to rise dramatically. Stack performance, in electrolysis or power generation mode, also begins to fall off. Indeed, at stack voltages of 100 V or more, permanent damage to the stack occurs.

In other embodiments, the concentration of CO₂ in the electrolysis hydrogen stream is monitored and electrolysis mode operation may be interrupted if the CO₂ concentration reaches or exceeds a limit concentration and resumed at such time that positive electrode catalyst activity has been at least partially restored.

In other embodiments, power source 84 is a constant current source that is clamped at a limit voltage. As indicated in FIG. 6, in embodiments of the present power plant incorporating NEXA™ fuel cell stacks a limit voltage of about 90 V—roughly twice the open current voltage of the stack—may be suitable. A suitable limit voltage for a given application may be empirically determined by operating the stack in electrolysis mode and measuring the concentration of carbon dioxide in the electrolysis hydrogen gas as a function of stack voltage, for example, and identifying a limit voltage that corresponds to an acceptable level of oxidation of the fuel cell components. Persons skilled in the art can readily determine other suitable indicators of component oxidation as a function of stack voltage for a particular type and size of fuel cell stack. Electrolysis mode operation may be interrupted if the stack voltage reaches or exceeds the limit voltage and resumed at such time that positive electrode catalyst activity has been at least partially restored.

In further embodiments, when the present power plant is operated in electrolysis mode a parameter indicative of the oxidation state of the catalyst at the positive electrodes is monitored. Electrolysis mode operation may be interrupted if the measured parameter indicates an undesirable loss in catalytic activity, and resumed at such time that positive electrode catalyst activity has been at least partially restored. For example, cyclic voltammetry could be employed to measure the oxidation state of the catalyst. The particular parameter indicative of the catalyst oxidation, and the method employed to measure it, are not essential to the present invention and persons skilled in the art can select suitable such parameters and measuring methods for a given application.

In other embodiments of the present method, the regenerative fuel cell stack is operated intermittently in electrolysis mode. When the stack voltage reaches or exceeds a predetermined upper voltage limit, electrolysis mode is interrupted by disconnecting the power supply and applying an electrical load to the stack until the stack voltage drops to or below a lower voltage limit. In further embodiments, instead of applying an electrical load to the stack, the stack is shorted until the stack voltage drops to or below a lower voltage limit. Again, without being bound by theory, it is believed that this introduces hydrogen (or hydrogen ions) into the positive electrode space of the fuel cells and consumes oxygen (present as adsorbed oxygen or oxides), which reduces the catalyst and restores its activity. Electrolysis mode may then be resumed. This sequence may be repeated until the hydrogen storage is filled or power generation mode is initiated.

Of course, practice of the present method is not limited to the present power plant. Electrolyzers may also be operated according to the present method. In some embodiments, an electrolyzer may be supplied with a humidified carrier gas and operated in the same manner as the regenerative fuel cell stack in electrolysis mode, described above. The present method may also be employed with liquid feed electrolyzers; intermittent operation, as described in the foregoing paragraph, is anticipated to assist in maintaining or restoring catalyst activity in such electrolyzers, as well.

The positive electrode space will contain oxygen as a product of electrolysis; the humidified carrier gas may also be a source of oxygen. The greater the partial pressure of oxygen in the positive electrode space, the more hydrogen will need to be consumed in order to reduce the catalyst to an acceptable degree. This, in turn, may increase the time required to reduce the catalyst and consume an undesirable amount of hydrogen that would otherwise be stored. Thus, in other embodiments, the present method further comprises reducing or interrupting the supply of humidified gas to the stack. Where the carrier gas comprises oxygen, this may reduce the amount of oxygen that must be consumed in order to establish reducing conditions in the positive electrode space. In turn, the amount of time and hydrogen required to reduce the catalyst may be shortened. Where the carrier gas does not comprise oxygen, though, it may be more efficient to continue supply of the humidified gas, as this may flush evolved oxygen from the positive electrode space and assist in establishing reducing conditions.

Turning now to FIGS. 2-4, when the voltage of stack 10 reaches or exceeds a limit voltage in electrolysis mode, switch 82 disconnects power supply 84 from stack 10 and a load is applied to stack 10. Switch 82 may connect stack 10 with load 86 or current sink 88, if desired. Alternatively, switch 82 could be configured to short stack 10, if desired.

Air supply to stack 10 may also be interrupted by shutting off compressor 40, for example, and/or shutting valve 52. The power plant may also include valve 54 that prevents air from entering the stack via oxidant outlet 30, if desired. Once sufficient catalyst activity is restored, electrolysis mode is resumed by reconnecting power source 84 and supplying humidified air to stack 10.

Other embodiments of the present method further comprise interrupting supply of humidified gas and circulating an oxygen-depleted gas. In FIG. 4, for example, compressor 40 may be shut off and valves 52 and 54 may be switched to allow circulation of gas via pump 56. While a load is applied to stack 10, oxygen in the circulating gas is depleted, facilitating reduction of the positive electrode catalyst. In effect, a substantially inert gas stream may be generated from a humidified carrier gas comprising oxygen (air, for example). At the same time, water source 46 may continue to humidify the circulating gas, if desired. In PEM fuel cell applications, for instance, this may also allow for independent control of the water content in the fuel cell membrane.

In some embodiments, the present power plant may be employed as part of a back-up power or UPS system. For example, in the embodiments of FIGS. 2-4 the utility grid can supply load 86 with power during normal operation. If the grid fails, hydrogen from supply 20 and air from compressor 40 are supplied to stack 10, and switch 82 connects stack 10 to load 86 to provide power thereto. In “instant on” applications, for example, the present power plant may further comprise one or more energy storage devices, such as storage batteries, super-capacitors or flywheels, for supplying power to load 86 until stack 10 reaches its rated output.

Once the grid is restored, switch 82 connects power supply 84 to stack 10 and electrolysis mode is initiated, as described above. In most back-up power or UPS applications power supply 84 typically comprises a rectifier receiving AC power from the utility grid, although other power supplies may be employed. Stack 10 is then operated in electrolysis mode until hydrogen storage 20 is replenished or the grid fails again.

In other embodiments, the present power plant may be employed as part of a peak power system. The system may be configured and operated as a back up or UPS system, described above, except that the power plant provides power during periods of peak use. Thus, in the embodiments of FIGS. 2-4, stack 10 may be connected and supplying power to load 86 instead of or in addition to the utility grid during peak use periods.

In electrolysis mode the hydrogen storage of the present power plant may be recharged at a 6×-10× rate, similar to current VRLA battery systems, if desired. This means it would take six to ten times longer operating in electrolysis mode to supply a given amount of hydrogen to the hydrogen storage than it takes to consume the same amount of hydrogen in power generation mode. This permits operation of the stack at lower current in electrolysis mode relative to power generation mode. At lower currents the stack operates at higher efficiency, which may decrease the unit cost of the hydrogen that is generated.

In applications where a longer recharge rate is acceptable (i.e., >10×), the applicant has found that it is possible to operate the present power plant using ambient air as humidified carrier gas. In order to compensate for the lower water content in ambient air, the stack may be operated at lower currents than is the case with a saturated air stream. Higher air flow rates may also be employed during operation on ambient air.

Thus, in some embodiments of the present power plant, the humidified carrier gas supplied to the stack in electrolysis mode is ambient air. In further embodiments, both the oxidant stream and the humidified carrier gas are ambient air. The PEM fuel cells and method of operation described in U.S. Pat. No. 6,451,470, for example, may be employed for the regenerative fuel cell stack in such embodiments.

The present power plant and operating method provide for a system that is smaller and lighter than conventional power supply systems employing VRLA batteries. The present power plant may also provide for “instant on” operation with improved hydrogen consumption rates as compared to systems in which fuel cell stacks are continuously running.

The present power plant also provides for hydrogen generation and storage at lower cost and complexity compared to power supply systems employing fuel cell stacks and electrolyzers.

The present power plant and operating method further provide for operation of a stack in electrolysis mode using a humidified carrier gas instead of liquid water. This may shorten the delay in providing power when switching from electrolysis mode to power generation mode, since liquid water need not be purged from the cells in order to generate power. In addition, this may provide for increased operational lifetime, as fuel cell components cannot be washed out of the stack.

All of the above U.S. patents, U.S. patent application publications, U.S. patent applications, foreign patents, foreign patent applications and non-patent publications referred to in the this specification and/or listed in the Application Data Sheet, are incorporated herein by reference in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of operating a regenerative fuel cell electric power plant having a stack, the method comprising:
in a power generation mode,
supplying an oxidant gas comprising oxygen and a fuel gas comprising hydrogen to the stack to generate electric power, and
supplying the electric power to a first electrical load; and
in an electrolysis mode,
supplying a humidified carrier gas to the stack,
applying an electric current to the stack,
electrolyzing at least a portion of the water in the carrier gas to generate hydrogen and an exhaust gas, and
storing at least a portion of the generated hydrogen.

2. The method of claim 1 wherein the oxidant gas comprises air.

3. The method of claim 1 wherein the oxidant gas is humidified.

4. The method of claim 1 wherein the fuel gas is substantially pure hydrogen.

5. The method of claim 1 wherein the carrier gas comprises air.

6. The method of claim 1 where the humidified carrier gas is ambient air.

7. The method of claim 1 wherein the carrier gas comprises an inert gas.

8. The method of claim 1, further comprising storing at least a portion of the exhaust gas.

9. The method of claim 1 wherein the hydrogen is stored as a pressurized gas.

10. The method of claim 1 wherein the hydrogen is stored as a liquid.

11. The method of claim 1 wherein the hydrogen is stored in a storage medium selected from the group consisting of metal hydrides, chemical hydrides and carbon nanomaterials.

12. The method of claim 1 wherein electrolyzing generates a gas stream comprising hydrogen and water, the method further comprising removing at least a portion of the water from the gas stream.

13. The method of claim 12 wherein the water is removed before storing the hydrogen.

14. The method of claim 12, further comprising storing the water and using the water to humidify one or more of the carrier gas, the oxidant gas and the fuel gas.

15. The method of claim 1 wherein the current is applied to the stack by a constant current source.

16. The method of claim 15 wherein the constant current source is clamped at a limit voltage.

17. The method of claim 16 wherein the limit voltage is about twice the open current voltage of the stack.

18. The method of claim 1, further comprising, in the electrolysis mode,
measuring the stack voltage,
interrupting applying the electric current to the stack when the stack voltage reaches or exceeds a predetermined upper voltage limit, and
re-applying the electric current to the stack when the stack voltage drops to or below a predetermined lower voltage limit.

19. The method of claim 18, further comprising connecting a second electrical load across the stack before re-applying the electric current.

20. The method of claim 18, further comprising electrically shorting the stack before re-applying the electric current.

21. The method of claim 18, further comprising interrupting supplying the humidified carrier gas to the stack before re-applying the electric current.

22. The method of claim 1 wherein the fuel gas is substantially pure hydrogen and the generated hydrogen is stored with the fuel.

23. The method of claim 1 wherein the stack is operated in power generation mode at a current higher than the current applied to the stack in electrolysis mode.

24. The method of claim 1 wherein the power plant further comprises a storage battery connectable to the electrical load, the method further comprising, in the power generation mode,
connecting the battery to the load in a first time period,
connecting the stack to the load in a second time period when the stack reaches a predetermined power output, and
disconnecting the battery from the load.
